(19) United States
(12) Patent Application Publication
(10) Pub. No.: US 2013/0290046 A1
(43) Pub. Date: Oct. 31, 2013

(54) SCHEMATIC CORPORATE DEVICE AND SYSTEM

(71) Applicant: Bartosz Jesman, Ringwood North (AU)

(72) Inventor: Bartosz Jesman, Ringwood North (AU)

(73) Assignee: FINSUITE PTY LTD, Victoria (AU)

(21) Appl. No.: 13/459,622

(22) Filed: Apr. 30, 2012

(51) Int. Cl. G06Q 10/00; G06F 17/30

(52) U.S. Cl. 705/7.11; 707/769; 707/E17.014

(57) ABSTRACT

A method for the creation of a schematic corporate relationship representations with respect to at least one identified individual or corporate entity, organising the information, and displaying it in the form of a schematic corporate relationship representations, including executing a set of algorithms by said system program for determining a schematic representations of the one or more entities if there is a defined one or more relationships between the one or more entities and rejecting any unrelated entities.

### FIELD OF THE INVENTION

The present invention relates to a schematic corporate device and system, and more particularly, to a device and system for providing schematic corporate relationship representations.

### BACKGROUND TO THE INVENTION

Corporate family trees (CFTs) are a visual representation of the relationships between various related entities, including individuals, trusts and corporations. CFTs are used by banks, accounting firms, financial planners, solicitors, credit unions, insurance companies, police departments and other industries. In today's environment, Corporate Family Trees are a key component of credit structuring, tax accounting, financial planning, fraud and criminal investigations.

Today, when an individual wishes to construct a schematic corporate relationship representation, they will often search many relevant corporate databases. This can include the government organizations in charge of corporate matters such as in Australia the records of the Australian Securities & Investments Commission (ASIC), or a private broker of the ASIC data or telephone directories, court case directories, etc.

From this information, they will construct an inconsistent schematic corporate relationship representation from the available information. A schematic corporate relationship representations constructed in this manner may often be incomplete since it relies on the searches undertaken. As such, it may only cover a few of the essential relevant elements unless a schematic corporate relationship representation had previously been constructed. Also, there can be other sources of information including government and corporate records.

The sources, however, may be difficult and time-consuming to review and may involve extensive searches to obtain the relevant data. Also, in many cases, an individual may need to know the relevance and need to search the relevant database.

Once the relevant information has been obtained, the person will need to construct the schematic corporate relationship representations. There is not a commercial system to do this. Instead the individual usually uses known system such as Word or Excel to create relationship representations. While this data and technique will be sufficient to create a simple basic schematic corporate relationship representation, it will lack substantial information for particularly usual complex corporate structures that could provide a more beneficial schematic corporate relationship representation. Further the schematics can be very offset as the information is collected at different times. The look will not be consistent or based on any rules. It is further up to the skill of the individual.

It can be seen there is a need to provide a simple, effective, and inexpensive way to gather information and to construct a schematic corporate relationship representations whether for a simple corporate relationships or more complex relationships.

Further instead of using standard tree structures it is necessary to provide a schematic result that assists in understanding of the corporate relationships. Unlike a family tree of individuals, a group of corporate entities can have many relationships and many types of relationships. For this reason, conventional family tree system and flowchart system is limited in how it can assist in the production of a Corporate Family tree.

Today's CFT's are typically created in Word, Excel or Visio, without any guidelines on how to construct one and no standard formats. Typically, relationships are unclear, detail is extremely varied depending on the author, formatting is both time consuming and can create additional confusion.

The present invention seeks to solve or at least ameliorate one or more of these problems by utilizing a communication network, such as the Internet, to allow people to search a variety of servers linked to the network, for information that can be used to construct the schematic corporate relationship representations.

### SUMMARY OF THE INVENTION

In accordance with one aspect of the present invention there is provided a method for the creation of a schematic corporate relationship representations with respect to at least one identified individual or corporate entity, organising the information, and displaying it in the form of a schematic corporate relationship representations, comprising the steps of: receiving information about a plurality of entities being at least one identified individual and at least one corporate entity; receiving information about relationships between at least one identified individual and the at least one corporate entity; and executing a set of algorithms by said system program for determining a schematic representations of the one or more entities if there is a defined one or more relationships between the one or more entities and rejecting any unrelated entities.

The Corporate Family Tree program enables a user to generate a schematic view of the relationships between various entities in a group. A schematic diagram represents the elements of the corporate using abstract, graphic symbols rather than realistic pictures. Further the schematic can omit all details that are not relevant to the information the schematic is intended to convey, and may add unrealistic elements that aid comprehension. For example, a subway map intended for riders may represent a subway station with a dot; the dot doesn't resemble the actual station at all but gives the viewer information without unnecessary visual clutter. A schematic diagram of a chemical process uses symbols to represent the vessels, piping, valves, pumps, and other equipment of the system, emphasizing their interconnection paths and suppressing physical details. In the schematic diagram, the symbolic elements are arranged to be more easily interpreted by the viewer.

A tool is provided to generate corporate family tree (CFT) diagrams. The primary focus of the CFT program is to automate and improve the overall presentation and standardisation of CFT's.

The tool can use an algorithm which incorporates a grid that attempts to place entities as close to the centre as possible, testing each grid position for intersecting lines in an expanding ‘snail shell’ pattern extending away from the centre and includes the key requirements of limited amount of boxes (42), making the algorithm more feasible.

In another form the tool implements a simulated annealing graph layout algorithm. Simulated Annealing is a general-purpose optimization method used to solve large-scale combinatorial problems by simulating the process of heating and cooling of metal to achieve freedom from defects. Finding a nice arrangement of a graph is a combinatorial problem that can be reduced to assigning costs to graph configurations and finding the minimum cost configuration. In that case, a cost is assigned to a graph configuration by evaluating different aesthetic criteria such as distance between nodes, length of links and the number of link crossings.

The AnnealLayout class implements a Simulated Annealing graph layout algorithm that can be used to arrange diagrams. The algorithm starts the simulation with the temperature set through setInitialTemperature, and runs several cooling stages, as specified by setStages. At each stage the algorithm evaluates several graph configurations for each node, as set by calling setIterationsPerStage. At the end of each stage, the algorithm selects the configuration that has a minimum cost and decreases the temperature by multiplying it by getTemperatureScale. The relative weight of an aesthetic criterion relative to the other criteria is set by the setDistributionFactor, setLinkLength Factor, setBoundaryFactor and setCrossingLinksCost methods.

System updates are made available via a web link and the solution is able to be supported on common platform such as Microsoft XP and above. The tool uses a user friendly, step-by-step wizard style interface.

It can be seen that the CTF program allows a user to input simple information about an entity and define its relationships to other entities. It then uses an algorithm to convert the information into a visual diagram of the group. The benefits include significant time reduction by automatically formatting the CFT, faster decisions due to a standardised look and feel, and improved decisions due to a robust understanding of the group

The Standard Edition includes the following features:
Ability to generate a Corporate Family Tree with no limit to the amount of entities
Allows the user to define the relationships between entities
Allows the user to define share of ownership of related entities
Allows the user to define the function of an entity, i.e. whether it is a trading entity, holding entity, etc.
Allows the user to enter detailed comments on each entity
Allows the user to manipulate the end output by dragging entities around the page
The CFT can be saved for later use, exported to JPG or PDF

The key enhancements are as follows:
Allow the user to play a demonstration the security pledged by various entities in a lending transaction
Standardised comments templates depending on entity type
Allow the user to define sub-groups
Allow the user to colour-code entities and define the colour in the legend
Additional Entity Function types

Improved versions of the CFT program, include:

### Integrated Edition:

Integration with ASIC reporting to allow a search of a single entity to identify all related entities and their relationships and automatically generate the Corporate Family Tree. Only Trusts need to be added by the user.

Banker's Edition:
Integration with ASIC as with the Integrated Edition
Allow the user to enter financial information on each entity (P&L and Balance Sheet)
Allow the user to define what security is held/to be taken/released for each entity
Allow the user to create a Tree view of security held
Allow the user to define what facilities each entity has (lending & transactional)

In accordance with another aspect of the present invention there is provided a method for gathering information relevant to the creation of a schematic corporate relationship representations, organizing the information, and displaying it in the form of a schematic corporate relationship representations, comprising the steps of searching databases through a network and scanning the database for relevant information, reviewing the information according to a set of criteria for relationships to other individuals or corporate entities and providing the information, along with the determined relationship to the user for acceptance or rejection and updating the database upon acceptance by the user.

In accordance with still another aspect of the present invention there is provided method for automatically compiling a schematic corporate relationship representations, comprising the steps of the system first determining the corporate entities and their relationships and locally schematically displaying the arrangement and the system second determining the relationships of the individuals to the corporate entities and schematically displays the arrangement in a satellite arrangement relative to the locally schematically displaying the arrangement of the corporate entities to provide a condensed ordered schematic of the combined corporate entities and individuals.

The method can automatically compiling a schematic corporate relationship representations by the system first determines the primary corporate entities and their relationships with secondary corporate entities and locally schematically displays the arrangement in an organic extending manner. The organic extension can be vertically arranged or horizontally arranged or arranged in an expanding manner. In one form the organic extension is arranged in a grid manner. The system can further determine the relationships of the related entities to the primary corporate entities and schematically displays the arrangement in a satellite arrangement relative to the locally schematically display arrangement of the primary corporate entities to provide a condensed ordered schematic of the combined corporate entities and individuals.

In accordance with yet still another aspect of the present invention there is provided a system product for automatically compiling a schematic corporate relationship representations such that when loaded onto a computer it would cause the computer to do the following steps of obtaining specified data about a corporate entity or individual, obtaining corporate data about a second related individual or corporate entity and determining relationship, automatically comparing the specified data of the plurality of entities of the first and second individuals and the defined relationships so as to determine the linkages and schematic view of the primary entities in a central localized manner and a secondary entities attached to the primary entities to form a cohesive schematic corporate relationship representations.

In accordance with another aspect of the present invention there is provided a computer system product for gathering information relevant to the creation of a schematic corporate relationship representations such that when loaded on to a computer will cause the computer to do the steps of searching databases through a network and scanning the database for relevant information, reviewing the information according to a set of criteria for corporate entities and relationships to primary corporate entities and individuals and providing the information, along with the criteria met to the user for acceptance or rejection and updating the schematic corporate relationship representations upon acceptance by the user.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

A preferred embodiment of the invention will now be described, by way of example only, with reference to the accompanying drawings, in which:

FIG. 1 is a diagrammatic flow diagram of a device and system for providing schematic corporate relationship representations

FIG. 2 is a computer screen shot of a entities screen in a wizard for use in the device and system for providing schematic corporate relationship representations of FIG. 1

FIG. 3 is a computer screen shot of a relationships screen in the Wizard of FIG. 2

FIG. 4 is an example of a resultant schematic corporate relationship representations created by the device and system for providing schematic corporate relationship representations of FIG. 1

FIG. 5 is a an embodiment of a legend for entities and relationships for use in defining resultant schematic corporate relationship representations created by the device and system for providing schematic corporate relationship representations of FIG. 1 such as shown in FIG. 4

FIG. 6 is an embodiment of particular relationships for use in defining resultant schematic corporate relationship representations created by the device and system for providing schematic corporate relationship representations of FIG. 1 such as shown in FIG. 4.

FIG. 7 is a diagrammatic flow diagram of an enhanced device and system for providing schematic corporate relationship representations relative to FIG. 1.

### DESCRIPTION OF A PREFERRED EMBODIMENT OF THE INVENTION

The invention provides a device and system for providing schematic corporate relationship representations.

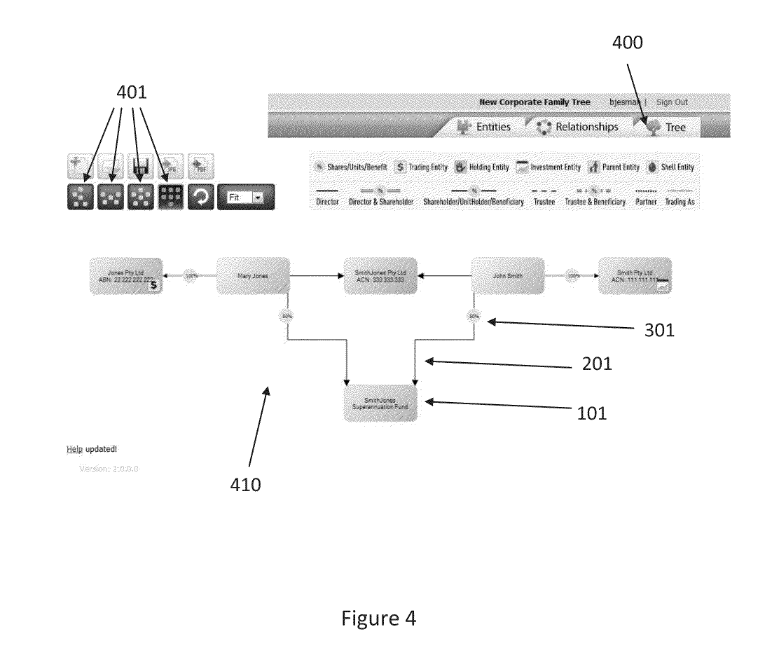

According to one aspect with reference to the drawings, the present invention provides the steps of:
1. User opens a program and is directed to the first tab (Entities Tab)
2. The Wizard then begins the process step (10) of determining the entities in a first page (100) in which the user enters details of the entities in the group specifying at least name and type of each entity. The user can also add the entity's ABN or ACN, define the function of the entity and add comments about the entity.
3. The Wizard then begins the process step (20) of determining the entities in a first page (200) in which the user enters details of the relationships between the entities in the group.
4. The system for providing schematic corporate relationship representations undertakes a determination of the entered entities and relationships under the process step (40) to provide a schematic corporate relationship representations (400) such as a CFT shown in the form of a corporate family tree of FIG. 4.

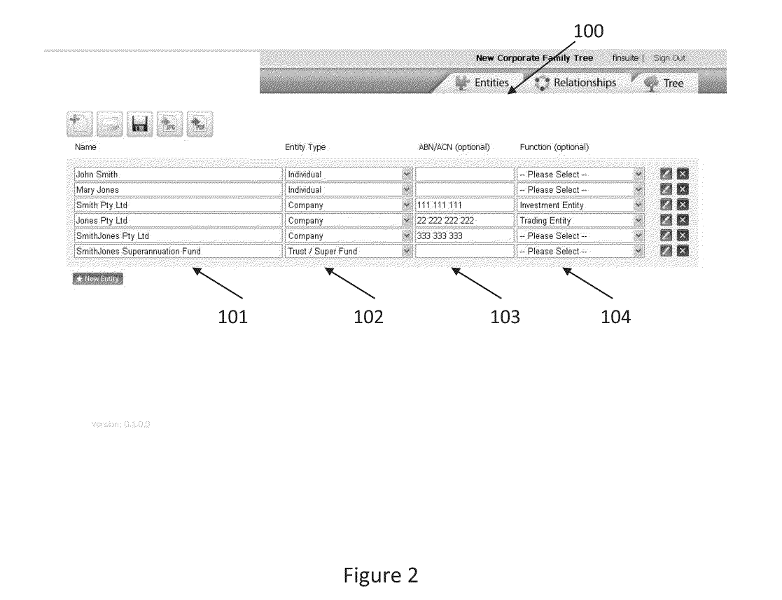

Referring in detail to FIG. 2, the first page (100) as identified by the tab at the top of screenshot provide a means of inputting relevant corporate entities and individuals. In particular at 101 there is the list of the names of the entities while at 102 there is an identifier of the entity type in a drop-down listing of types of entity such as individual, company, trust etc. Further this can be accompanied by particular corporate identifier numbers 103 such as in Australia which uses Australian business number ABN or Australian company number ACN. The entity is further defined by the entity function 104 which includes a drop-down listing of function of entity such as investment entity trading entity etc.

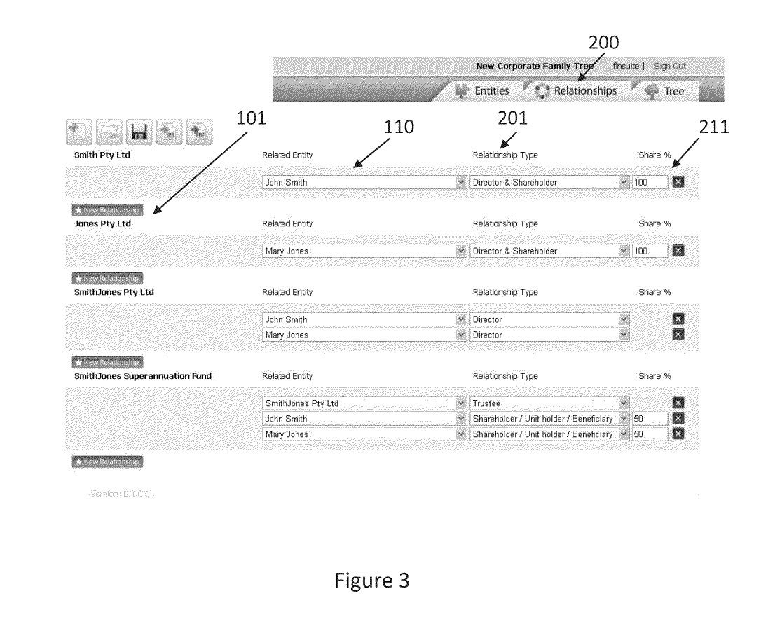

Referring to FIG. 3 there is shown by the tab at the top of page that this is a relationship page (200). This page therefore includes entities 101 as entered in the previous entities page 100 while allowing for further information such as related entities 110 to be included which are others of the predefined entities 101 but now defined to be particularly related to one or more primary entities 101. The type of relationship is identified at 201 between the primary entity 101 and the related entity 110. Further an intermediate qualifier 211 is included which can include a percentile share and is therefore a qualifier with regard to the relationship type.

With the entered entities 101 and relationships 201 on the entities page 100 and relationship page 200 there can now be formed a resultant schematic corporate relationship representations. However unlike usual tree diagrams or personal family trees there is no predefined or usual arrangement of these related entities. Therefore the entities must be schematically represented by an active algorithm that must review the entities and relationships in order to form a cohesive final schematic representation.

A first step in this approach can be by selection of a preferred organic schematic basis of drawing as shown as 401 in FIG. 4. This includes an organic vertical growth tree where primary corporate entities are first linked in a central substantially vertical extending line while secondary related entities are linked on one or both sides. Another version can include our organic horizontal growth tree with primary corporate entities first linked in a central substantially horizontal extending line above or below that line. A further option can be a multidirectional organic growth tree wherein the system first determines the corporate entities and their relationships and locally schematically displays the arrangement and the system second determines the relationships of the individuals to the corporate entities and schematically displays the arrangement in a satellite arrangement relative to the locally schematically displays the arrangement of the corporate entities to provide a condensed ordered schematic of the combined corporate entities and individuals.

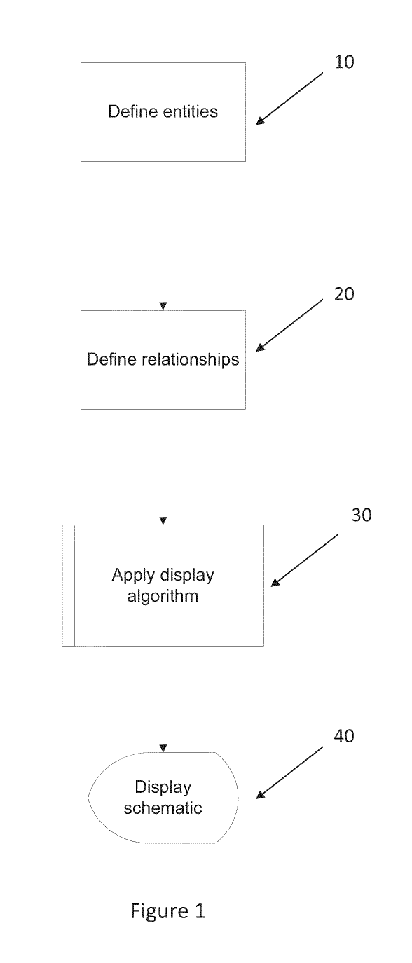

The system undertakes step 30 of FIG. 1 by using a simulated annealing graph layout algorithm. This algorithm of simulated annealing is a general-purpose optimization method used to solve large-scale combinatorial problems by simulating the process of heating and cooling of metal to achieve freedom from defects. Finding a nice arrangement of a graph is a combinatorial problem that can be reduced to assigning costs to graph configurations and finding the minimum cost configuration. In that case, a cost is assigned to a graph configuration by evaluating different aesthetic criteria such as distance between nodes, length of links and the number of link crossings.

The AnnealLayout class implements a Simulated Annealing graph layout algorithm that can be used to arrange diagrams. The algorithm starts the simulation with the temperature set through setInitialTemperature, and runs several cooling stages, as specified by setStages. At each stage the algorithm evaluates several graph configurations for each node, as set by calling setIterationsPerStage. At the end of each stage, the algorithm selects the configuration that has a minimum cost and decreases the temperature by multiplying it by getTemperatureScale. The relative weight of an aesthetic criterion relative to the other criteria is set by the setDistributionFactor, setLinkLength Factor, setBoundaryFactor and setCrossingLinksCost methods.

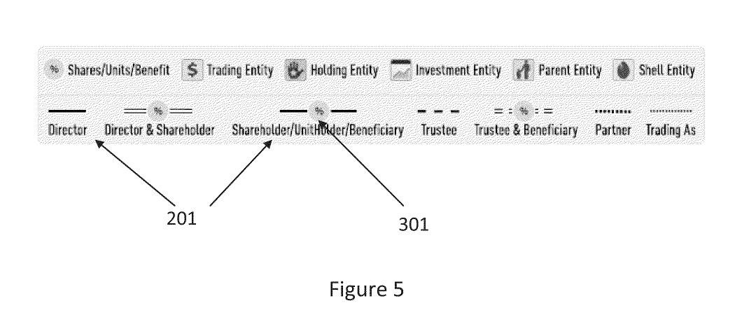

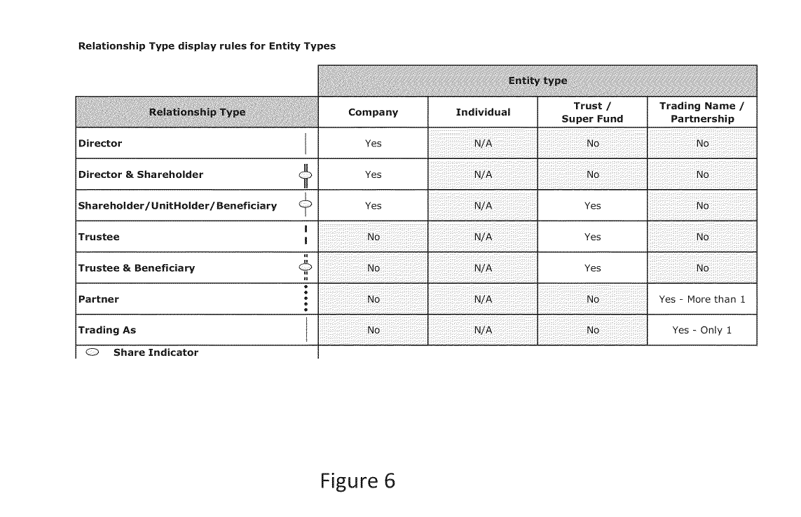

FIGS. 5 and 6 show an embodiment of a legend for entities and relationships for use in defining resultant schematic corporate relationship representations. FIG. 6 shows particular relationships for use in defining resultant schematic corporate relationship representations created by the device and system for providing schematic corporate relationship representations of FIG. 1 such as shown in FIG. 4. The type of line connecting two entities depicts the relationship between the two entities. Further the relationship can include a relationship modifier such as a percentile indicator of shareholding, unit holding or benefit and this relationship modifier can be shown in a box overlying the line connecting the two entities.

Relationships must follow rules and include that all entities must eventually connect to at least one of each other. If an entity is unrelated it needs to be rejected and identified as a rejected entity such that further information including relationship can be found for this entity. Rejection can be an error message or request further information. Individuals cannot be related to individuals as this is a corporate relationship representation and not a personal relationship representations. A partnership entity must have at least two Partner relationship types defined for it. If not an error message or request further information must issue. A sole trader entity must have only one sole trader relationship type defined for it. Otherwise an error or request further information is required. Other entity and relationship rules which are predetermined can be incorporated in the system.

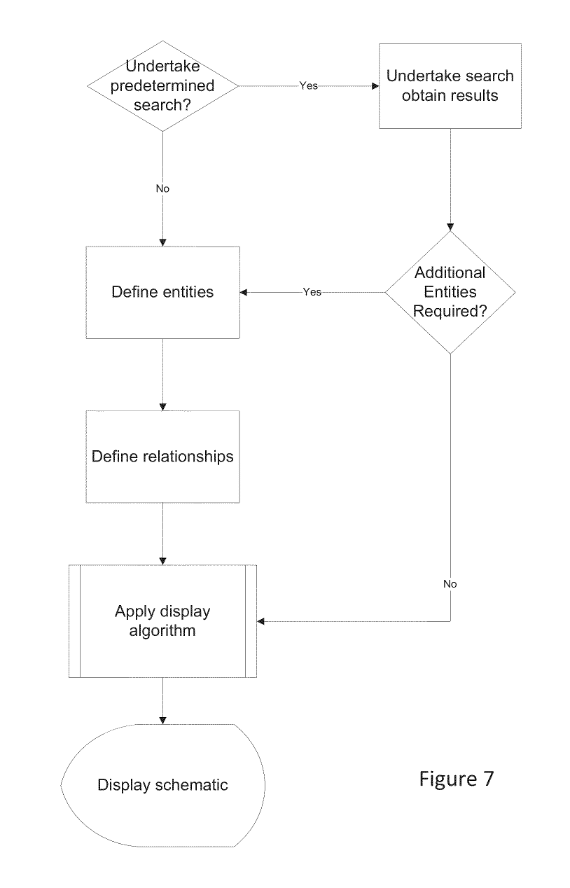

Referring to FIG. 7, a flow chart describes one enhanced method of operation of the present invention. An individual wishing to construct a schematic corporate relationship representations first launches the system, step 10 on a personal computer. Once the system has been launched a set of screens is brought forth onto which the user may enter information about the entities whose corporate tree is being created.

The user can choose to either enter the entities manually or search for the entities, which causes the system to connect to the Internet and, through the use of its search engine, look for other references to the corporate entities. The system will return information about corporate entities from predetermined databases which according to the predetermined criteria are likely to be related to the corporate entity and this information is presented with the opportunity to accept or reject the further information about the corporate entity. The user then can decide to accept or not the automatically assessed likelihood of related entity and/or relationship.

If the user decides to accept, the system will update the entities and/or relationships darter with the new information linking each of the accepted entities and/or relationships with the appropriate entity or entities in the schematic corporate relationship representations. If the user opts to reject the proposed entities all relationships, the database will not be updated and the user will be directed to add entities manually. This process continues until the user has accepted or rejected all of the searched entities or relationships in the predetermined searched databases.

Once the initial schematic corporate relationship representations has been created, the system that maintains the schematic corporate relationship representations can set up to review the schematic corporate relationship representations, and can be automatically updated on the schematic corporate relationship representations of the entities and/or relationships.

It is to be understood that various modifications and changes may be made without departing from the present invention, the present invention being defined by the following claims.

Those of skill in the art will appreciate that such modifications or changes to the particular embodiments exemplified can be made without departed from the scope of the invention. All such modifications and changes are intended to be included within the scope of the appended claims.

1. A method for the creation and display of a schematic corporate relationship representation with respect to at least one identified individual or corporate entity, comprising the steps of:
a. receiving information about one or more entities being at least one identified individual and at least one corporate entity;
b. receiving information about relationships between the at least one identified individual and the at least one corporate entity; and
c. determining, and allowing for display, a schematic representation of the one or more entities and the one or more relationships between the one or more entities.

2. A method according to claim 1 wherein the system wherein the step of receiving information about relationships between the at least one identified individual and the at least one corporate entity includes searching predetermined databases according to predetermined criteria with regard the one or more entities.

3. A method according to claim 2 wherein the system undertakes an automatic search over a communication network for obtaining relevant information regarding at least one entity for inclusion in said schematic corporate relationship representation.

4. A method according to claim 3 wherein the system allows for indication of the probability that the information regarding the one or more entities is related and therefore relevant.

5. A method according to claim 2 wherein the system allows for the user to accept or reject the searched material and to update the schematic corporate relationship representations upon acceptance by the user.

6. A method according to claim 1 wherein the system displays an entity according to predetermined indicators.

7. A method according to claim 6 wherein the system displays relationships between entities according to predetermined relationships indicators.

8. A method according to claim 7 wherein the system displays an intermediate indicator in association with the predetermined relationships indicators wherein the predetermined intermediate identifier qualifies the relationship such as by percentile indicators.

9. A method according to claim 1 wherein the system
a. first determines the corporate entities and their relationships and locally schematically displays the arrangement and
b. the system second determines the relationships of the individuals to the corporate entities and schematically displays the arrangement in a satellite arrangement relative to the locally schematically displays the arrangement of the corporate entities
c. wherein the system provides a condensed ordered schematic of the combined corporate entities and individuals.

10. A method according to claim 9 wherein the system first determines the primary corporate entities and their relationships with secondary corporate entities and locally schematically displays the arrangement of any additions or edits in an organic extending manner.

11. A method according to claim 10 wherein the system further determines the relationships of the related entities to the primary corporate entities and schematically displays the arrangement in a satellite arrangement relative to the locally schematically display arrangement of the primary corporate entities to provide a condensed ordered schematic of the combined corporate entities and individuals.

12. A method according to claim 10 wherein an input/output means for receiving the information and producing the schematic corporate relationship representations is connected to the internet.

13. A method according to claim 10 wherein the individuals and corporate entities are related not through corporate ownership relationships but due to other corporate relationships.

14. A method according to claim 13 wherein said experience is a secondary relationship such as licensee.

15. A method according to claim 10 wherein the user has the option to approve or not approve said additions or edits.

16. A method for automatically compiling a schematic corporate relationship representations for gathering information relevant to the creation of a schematic corporate relationship representations, organizing the information, and displaying it in the form of a schematic corporate relationship representations, comprising the steps of:
a. searching databases through a network and scanning the databases for relevant information,
b. reviewing the information according to a set of criteria for relationships to other individuals or corporate entities and
c. providing the information, along with the determined relationship to the user for acceptance or rejection and
d. updating the database upon acceptance by the user.

17. A method according to claim 16 for automatically compiling a schematic corporate relationship representations, comprising the steps of:
a. determining the corporate entities and their relationships and locally schematically displaying the arrangement and
b. determining the relationships of the individuals to the corporate entities and
c. schematically displaying the arrangement in a satellite arrangement relative to the locally schematically displaying the arrangement of the corporate entities to provide a condensed ordered schematic of the combined corporate entities and individuals.

18. A method according to claim 17 including automatically compiling a schematic corporate relationship representations by the system
a. determining the primary corporate entities and their relationships with secondary corporate entities; and
b. locally schematically displaying the arrangement in an organic extension manner;
c. the organic extension being vertically arranged or horizontally arranged or arranged in an expanding manner;
d. arranging the organic extension in a grid manner.
e. determining the relationships of the related entities to the primary corporate entities and
f. schematically displaying the arrangement in a satellite arrangement relative to the locally schematically display arrangement of the primary corporate entities to provide a condensed ordered schematic of the combined corporate entities and individuals.

19. A system product for automatically compiling a schematic corporate relationship representations such that when loaded onto a computer it would cause the computer to do the following steps of:
a. obtain specified data about a corporate entity or individual;
b. obtain corporate data about a second related individual or corporate entity and determining relationship;
c. automatically compare the specified data of the plurality of entities of the first and second individuals and the defined relationships; and
d. determine the linkages and schematic view of the primary entities in a central localized manner and a secondary entities attached to the primary entities to form a cohesive schematic corporate relationship representations.

20. A system product according to claim 19 for gathering information relevant to the creation of a schematic corporate relationship representations such that when loaded on to a computer will cause the computer to do the steps of:
a. searching databases through a network and scanning the database for relevant information;
b. reviewing the information according to a set of criteria for corporate entities and relationships to primary corporate entities and individuals;
c. providing the information, along with the criteria met to the user for acceptance or rejection; and
d. updating the schematic corporate relationship representations upon acceptance by the user.
